(19) United States
(12) Patent Application Publication
(10) Pub. No.: US 2017/0237813 A1
(43) Pub. Date: Aug. 17, 2017

(54) DATA TRANSMISSION SYSTEM AND METHOD FOR TRANSMITTING DATA

(71) Applicant: SIEMENS AKTIENGESELLSCHAFT, München (DE)

(72) Inventors: Klaus-Peter HOFMANN, Aurachtal-Muenchaurach (DE); Thomas RIPPLINGER, Karlsruhe (DE)

(73) Assignee: SIEMENS AKTIENGESELLSCHAFT, München (DE)

(21) Appl. No.: 15/434,585

(22) Filed: Feb. 16, 2017

(30) Foreign Application Priority Data
Feb. 17, 2016 (EP) 16156089.1

(51) Int. Cl. H04L 29/08; H04L 29/06; H04L 12/66

(52) U.S. Cl. CPC H04L 67/1097; H04L 12/66; H04L 63/0209; H04L 63/0428

(57) ABSTRACT

A data transmission system includes a first subscriber, a second subscriber, and an automation system including an automation network. The second subscriber is arranged in the automation network. A communication interface is provided to bidirectionally transmit data between the first subscriber and the second subscriber, with the communication interface being configured as an agent gateway.

### CROSS-REFERENCES TO RELATED APPLICATIONS

This application claims the priority of European Patent Application, Serial No. EP16156089.1 , filed Feb. 17, 2016, pursuant to 35 U.S.C. 119(a)-(d), the content of which is incorporated herein by reference in its entirety as if fully set forth herein.

### BACKGROUND OF THE INVENTION

The invention relates in general to a method for transmitting data and to a data transmission system including a first subscriber and a second subscriber.

The following discussion of related art is provided to assist the reader in understanding the advantages of the invention, and is not to be construed as an admission that this related art is prior art to this invention.

The term “automation system” when used with reference to an automated plant facility serves in the following to describe devices and installations, which are deployed for the purpose of controlling and/or monitoring a technical process, e.g. a manufacturing process, and are known per se. The devices include e.g. programmable logic controllers, decentralized peripheral devices, operator control and monitoring systems or the like, which are connected to one another by way of a data transmission entity, e.g. a LAN network (LAN=Local Area Network), to form a shared automation network. Such devices or networks are referred to collectively as automation components. In the “IoT” (Internet of Things) environment, data is collected and utilized in order to generate added values by analytical methods. In this context, the processing of the data is carried out on a centralized basis in an external data center or cloud system.

In order to make use of the added values, the plant operator passes on selected data to an analytics provider. The controlled decoupling of local plant data of an automation system by way of an Internet connection constitutes a particular challenge in this case. The plant operator would like transparency and full control over the type and extent of the forwarded data.

Typically, plant data is tapped from the automation system or other local devices of an automated plant facility (“IoT data”) by way of components known as “agents” within the local area network (LAN network). Software agents are in this case delimitable hardware/software entities which autonomously pursue defined objectives by interacting with their environment and other agents. In this case the agents are able to form an agent system by way of the LAN. The decoupling of the data is accomplished on the basis of specified data point transfer lists or transfer rules. That is to say, an agent reads data from the lower-level systems and forwards the data by way of an outgoing connection via the Internet to the cloud system. If a plurality of different data sources are present in the automation system (e.g. a plurality of subsystems or equipment units), a plurality of agents may be deployed under certain conditions. Standardized or vendor-specific protocols are used for transferring the data to the cloud system. Typically part of such protocols is a “data model”, which specifies the semantics (meaning) of the transferred data. A data model is a model of the automation system data that is to be described and processed and the relationships between the different sets of the data. Data models enable the structure for the data that is to be processed and stored in the systems to be determined and defined.

The lower-level systems, in particular, such systems belonging to earlier design generations, generally do not provide finely granular access control over the available data. The type and scale of the decoupled data are not always transparently visible. Furthermore, the data must be transmitted in encrypted form. Not all hardware supports the necessary encryption mechanisms, or alternatively increased expenditure on hardware and administration resources is required, e.g. by way of a VPN tunnel.

In this case, the agents read data from the lower-level automation system and forward the data by way of an outgoing connection via the Internet to the cloud system.

If a plurality of agents are deployed, the communication is usually bundled by way of an intermediary known as a proxy in the customer network, from where the transition is made into the Internet. Depending on the producer of the agent, different possibilities are available for the configuration of the data transfer (e.g. tool for compiling transfer lists).

However, no finely granular, independent control of the data flow from the automation system by the customer is possible using such a proxy. In the prior art it is normal practice at this stage to bundle the communication by way of a proxy, and from there, the transition is made into the Internet. However, the data traffic at the proxy is not transparently visible. Transparency and traceability are dependent on the configuration options offered by the deployed agent system. There is no “independent” instance for controlling the data flow. The data traffic at the central proxy (if present) is not transparently visible. The proxy therefore has no knowledge of the protocols and consequently cannot permit any finely granular intervention possibilities, e.g. blocking an agent of the automation system.

It would therefore be desirable and advantageous to provide an improved data transmission system between network subscribers and a method for transmitting data to obviate prior art shortcomings.

### SUMMARY OF THE INVENTION

According to one aspect of the present invention, a data transmission system includes a first subscriber, a second subscriber, an automation system including an automation network, the second subscriber being arranged in the automation network, and a communication interface configured to bidirectionally transmit data between the first subscriber and the second subscriber, the communication interface being configured as an agent gateway.

According to another aspect of the present invention, a method for transmitting data includes configuring a communication interface as an agent gateway to bidirectionally transmit data between a first subscriber and a second subscriber, and arranging the second subscriber in an automation network of an automation system.

To ensure clarity, it is necessary to establish the definition of several important terms and expressions that will be used throughout this disclosure.

The term “agent gateway” relates to a gateway which is embodied as an agent, or acts and interacts as such a gateway.

The term “agent” (software/software agent) relates to a software including a defined objective, which has at least one autonomous behavior, and which is capable of interacting with the environment and other agents. In this case, it may be a deliberative software agent, reactive software agent, or hybrid software agent.

The term “gateway” is in common use in information technology and is also to be understood in accordance with this meaning.

The term “data” relates in the disclosure in particular to machine and plant data.

In accordance with the present invention, the machine and plant data is now decoupled by way of a central agent gateway. In contrast to a conventional proxy, the agent gateway has knowledge of the data protocols used and consequently of the data models between “agent” and “cloud”. Full transparency in relation to outgoing data is made possible as a result, i.e. a transparent representation of the data traffic is possible.

Furthermore, selection of the data and finely granular control independent of the agent configuration are also possible as a result of the invention.

Further advantageous features are set forth in the dependent claims, and may be combined with one another in any desired manner in order to achieve further advantages.

According to another advantageous feature of the present invention, a data transmission network may be provided, with the first subscriber and the agent gateway being bidirectionally connected to the data transmission network. Advantageously, the data transmission network can be the Internet.

According to another advantageous feature of the present invention, the agent gateway can be arranged between the second subscriber and the data transmission network. In this case, a firewall may be interposed upstream and/or in addition downstream of the agent gateway for security reasons. This may be a standard firewall provided in order to increase data security.

According to another advantageous feature of the present invention, the first subscriber and the second subscriber can be physically separated from one another. In this arrangement, the second subscriber may be an external data center, and in particular, a data center for implementing cloud computing. This means that the second subscriber can advantageously be a computing resource known as a cloud.

According to another advantageous feature of the present invention, the first subscriber can be an agent system including an agent which taps plant data from the automation network and/or other local devices of the automation system.

According to another advantageous feature of the present invention, the agent gateway can be configured to selectively block or release the agent of the agent system.

According to another advantageous feature of the present invention, the agent gateway can be configured to selectively block or release a function of the agent of the agent system. This may involve, for example, a configuration update initiated remotely or file downloads. This means that the agent gateway assumes a filter function, a Lock Config Update, for example. “Metering and bandwidth shaping”, i.e. bandwidth speed testing and bandwidth allocation, is also possible therewith. Thus a limiting of the bandwidth used for the data transfer is made possible.

According to another advantageous feature of the present invention, the data can be encrypted in the agent gateway, i.e. at a central point. A secure transmission is assured as a result. This also enables a certification of the data, i.e. digital certificates for authentication, to be provided by a certification authority in the agent gateway. This means that an encryption is also possible even if this is not provided by the first subscriber, e.g. the agent in the local LAN of the automation system.

According to another advantageous feature of the present invention, the agent gateway can effectively assume an audit function. When a plurality of agents are available in the agent system, a listing of all available agents in the agent system can therefore be produced by the agent gateway. This is derived from the protocol and the data traffic. A listing of the metadata per agent (i.e. which data is sent to the cloud), which is derived from data model and data stream, is also possible. The data traffic can therefore be represented transparently.

According to another advantageous feature of the present invention, the data can be sent by the agent gateway in time-staggered fashion. In this case, the data of the agents is not sent until after a period of several hours or minutes has elapsed (time-delayed). It is also possible to send the data of the last predefined hours as and when necessary, a “send on demand” in service situations, as it were. This also allows the use of a circular buffer.

### BRIEF DESCRIPTION OF THE DRAWING

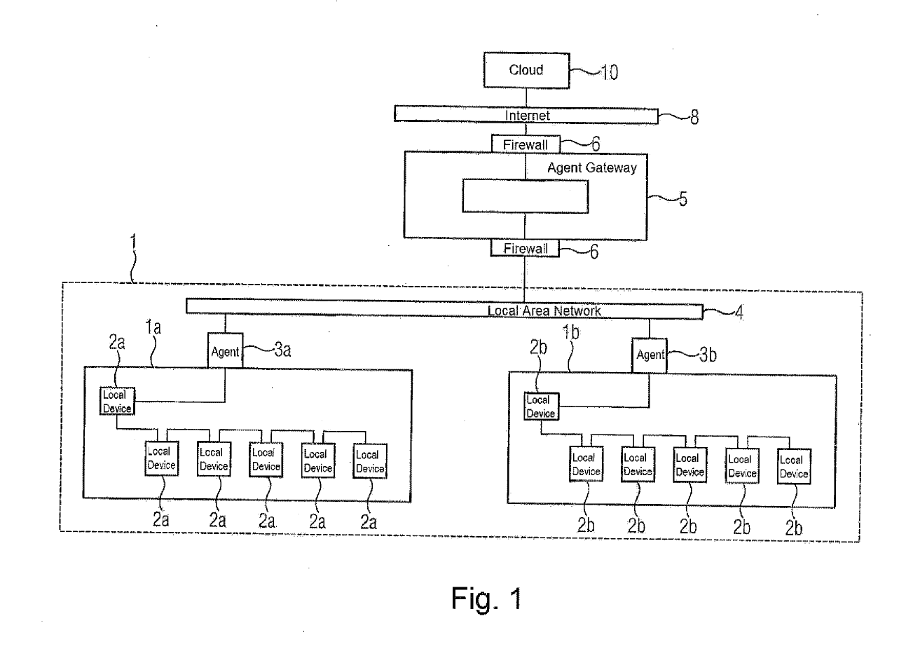

Other features and advantages of the present invention will be more readily apparent upon reading the following description of currently preferred exemplified embodiments of the invention with reference to the accompanying drawing, in which the sole FIG. 1 illustrates a data transmission system according to the present invention.

### DETAILED DESCRIPTION OF PREFERRED EMBODIMENTS

The depicted embodiment is to be understood as illustrative of the invention and not as limiting in any way. It should also be understood that the figure is not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to FIG. 1, there is shown an automation system 1 according to the present invention. In this arrangement, plant data from local devices 2a, 2b of a system unit 1a, 1b of the automation system 1 (“loT data”) is tapped via agents 3a, 3b within the local area network 4 (LAN network). In this context, software agents are delimitable hardware/software entities which autonomously pursue defined objectives by interacting with their environment and other agents. In this case the agents can form an agent system by way of the (corporate) LAN 4.

As described above, it is normal practice in the art at this stage to bundle the communication by way of a proxy, and from there the transition is made into the internet. However, the data traffic at the proxy is not transparently visible. Transparency and traceability are dependent on the configuration options offered by the deployed agent system. The proxy therefore has no knowledge of the protocols and consequently cannot permit any finely granular intervention possibilities, e.g. blocking an agent of the automation system. This is now avoided by the present invention.

According to the invention, an agent gateway 5 is now connected between the agents 3a,3b of the LAN 4 or, as the case may be, the agent system and the second subscriber. This may be a cloud 10 in this case. A firewall 6 may additionally be interposed upstream and/or downstream of the agent gateway 5. The agent gateway 5 receives the data of the agents 3a,3b via LAN 4 and forwards the data for example via or into a public Internet 8 to the cloud 10 provided for that purpose. So-called “private clouds” may of course also be provided where the data is provided by way of an internal corporate intranet.

Accordingly, the agent gateway 5 according to the invention also represents a central access point to the Internet 8 for the agents 3a,3b.

In this case the basic functionality of the agent gateway 5 is the forwarding of data. It is understood that standardized protocols or proprietary protocols (ISB) may continue to be used here. In contrast to a conventional proxy, however, the agent gateway has knowledge of the data protocols used, and hence of the data models between agent 3a,3b and cloud 10.

An example of a data model according to its present meaning may be found in the description of the figure. Such a data model for the data transfer from the agents 3a,3b to the cloud 10 may in this case appear e.g. as follows: In the system unit 1a/1b, measurement points 1, . . . ,n are provided which have data, e.g. the timestamp and measured values, and messages 1, . . . n, which have data, e.g. the timestamp and a message text:

System unit 1a:
Agent 3a
   -Measurement point 1 (data, e.g. timestamp, measured values)
   Measurement point 2 (data, e.g. timestamp, measured values) . . .
   Measurement point n (data, e.g. timestamp, measured values)
   Message 1 (data, e.g. timestamp, message text) . . .
Agent . . .

System unit 1b:
Agent 3b
   Measurement point 1 (data, e.g. timestamp, measured values)
   Measurement point 2 (data, e.g. timestamp, measured values) . . .
   Measurement point n (data, e.g. timestamp, measured values)
   Message 1 (data, e.g. timestamp, message text) . . .
Agent . . .
   Measurement point 1 (data, e.g. timestamp, measured values)
   Measurement point 2 (data, e.g. timestamp, measured values) . . .
   Measurement point n (data, e.g. timestamp, measured values)
   Message 1 (data, e.g. timestamp, message text) . . .

System unit n:
Agent 3n
   Measurement point 1 (data, e.g. timestamp, measured values)
   Measurement point 2 (data, e.g. timestamp, measured values) . . .
   Measurement point n (data, e.g. timestamp, measured values)
   Message 1 (data, e.g. timestamp, message text) . . .

The agent 3a,3b (to agent 3n, which is no longer mentioned in the following) may to some degree extract data from the data stream. A data model, may therefore, be described as a model of the data, that is to be described and processed and the relationships between the different sets of the data.

Through knowledge of the data model, the agent gateway 5 firstly enables the data traffic to be represented in a transparent manner. A listing of all agents 3a,3b within the automation system 1 may be derived from protocol and data traffic. From the data model and the data stream, it is furthermore possible, to derive a listing of the meta data and the data per agent, i.e. which data is sent to the cloud. Meta data, in this context, is data containing information about attributes of other data, but not the other data itself.

The present invention makes it furthermore possible to intervene in the data traffic. Thus, for example, agents 3a, 3b may be selectively blocked or released. Moreover, it is now possible also to block individual agent functions, e.g. a decision function, in a targeted manner. In this case, agent functions may include e.g. the blocking of file downloads, or e.g. a configuration update.

A time-staggered sending of the data is also possible by the invention. Thus, the data sent by the agents 3a,3b may be sent only after e.g. several hours have elapsed or, as the case may be, the data of the last hours may be sent to the cloud 10 only as and when necessary (send on demand). In this case, the agent gateway 5 may be equipped with a circular buffer having a fixed size.,

The bandwidth used for the data transfer may also be limited.

In addition, the data may be encrypted at the agent gateway 5, i.e. the encryption now takes place at a central point. This is advantageous in particular if no provision is made for this by the agent 3a,3b itself. A certification of the data, i.e. digital certificates for authentication, may also be provided by a certification authority in the agent gateway 5.

By virtue of the inventive transparent representation of the data traffic, it is furthermore possible to intervene in the data traffic and for an encryption of the data to be carried out at a central point.

Advantages to be cited as far as the automated plant operator is concerned are therefore in particular the audit function, i.e. full transparency over outgoing data, data control, selection, and finely granular control independent of agent configuration, as well as secure, encrypted transmission of the data.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A data transmission system, comprising:
a first subscriber;
a second subscriber;
an automation system including an automation network, said second subscriber being arranged in the automation network; and
a communication interface configured to bidirectionally transmit data between the first subscriber and the second subscriber, said communication interface being configured as an agent gateway.

2. The data transmission system of claim 1, further comprising a data transmission network, said first subscriber and said agent gateway being bidirectionally connected to the data transmission network.

3. The data transmission system of claim 2, wherein the data transmission network is an Internet.

4. The data transmission system of claim 2, wherein the agent gateway is arranged between the second subscriber and the data transmission network.

5. The data transmission system of claim 1, wherein the first subscriber and the second subscriber are physically separated from one another.

6. The data transmission system of claim 1, wherein the second subscriber is an external data center.

7. The data transmission system of claim 6, wherein the external data center is a cloud.

8. The data transmission system of claim 1, wherein the first subscriber is an agent system comprising an agent which taps plant data from the automation network and/or other local devices of the automation system.

9. The data transmission system of claim 8, wherein the agent gateway is configured to selectively block or release the agent of the agent system.

10. The data transmission system of claim 8, wherein the agent gateway is configured to selectively block or release a function of the agent of the agent system.

11. The data transmission system of claim 1, further comprising a firewall interposed upstream of the agent gateway.

12. The data transmission system of claim 11, wherein the firewall is interposed downstream of the agent gateway.

13. The data transmission system of claim 1, wherein the data is encrypted in the agent gateway.

14. The data transmission system of claim 8, wherein the agent system includes a plurality of agents, said agent system including a listing of all available agents being produced by the agent gateway.

15. The data transmission system of claim 14, wherein the agent gateway includes an audit function configured to:
list all available agents in the agent system;
filter the data; and
list the data and metadata sent by the agents.

16. A method for transmitting data, comprising:
configuring a communication interface as an agent gateway to bidirectionally transmit data between a first subscriber and a second subscriber; and
arranging the second subscriber in an automation network of an automation system.

17. The method of claim 16, wherein the agent gateway includes a data control function configured to:
send the data in a time-staggered manner;
filter the data; and
encrypt the data.

18. The method of claim 16, further comprising configuring the first subscriber as an agent system comprising an agent which taps plant data from the automation network and/or other local devices of the automation system.

19. The method of claim 18, further comprising selectively blocking or releasing the agent of the agent system.

20. The method of claim 18, further comprising selectively blocking or releasing a function of the agent of the agent system.

21. The method of claim 16, wherein the agent gateway includes an audit function configured to:
list all available agents in the agent system;
filter the data; and
list the data and metadata sent by the agents.
